(19) United States
(12) Patent Application Publication
(10) Pub. No.: US 2015/0379484 A1
(43) Pub. Date: Dec. 31, 2015

(54) INTERNATIONAL PAYMENT SYSTEMS AND METHODS

(71) Applicant: FEXCO, KILLORGLIN (IE)

(72) Inventor: John F. McCarthy, Killorglin (IE)

(21) Appl. No.: 14/314,329

(22) Filed: Jun. 25, 2014

(51) Int. Cl. G06Q 20/10; G06Q 20/42; G06Q 20/38

(52) U.S. Cl. CPC G06Q 20/10; G06Q 20/381; G06Q 20/42

(57) ABSTRACT

A method for effectuating an international payment may include receiving a request to make a payment for a purchase between a consumer and a merchant located in different countries. The request may be to pay for goods or services offered on a website of the merchant and may require a currency conversion. At least a portion of the request may be transmitted to a payment service provider and, in response, a payment amount in the consumer's currency along with a website address of the payment service provider may be received from the payment service provider. The payment amount and the website address may be transmitted to the merchant for display to the consumer to allow the consumer to communicate with the payment service provider to complete the payment transaction. A confirmation of payment may be received from the payment service provider and transmitted to the merchant to confirm payment of the goods or services.

### BACKGROUND OF THE INVENTION

Commerce is becoming increasingly more global. For example, it is not uncommon for consumers to purchase goods and/or services directly from merchants that are located in a separate country. The increase in international business is likely due to the increase in Internet usage and the convenience that online merchant websites provide to consumers. Although international commerce has increased, the ability to pay for desired goods and/or services remains relatively difficult. For example, many different regions around the world use online payment service providers that are relatively unique to a given region. Commerce within a given region may be relatively easy, since both the consumer and merchant may use the same online payment service provider. However, commerce with consumers or merchants outside the given region may be relatively difficult since the consumers and/or merchants may not be able to use the same online service provider.

The difficulty in paying for desired goods and/or services may limit the customer base for a given merchant or company. For example, consumers that are located remotely from a given merchant and outside of the coverage area of an online service provider that services the merchant may be discouraged from engaging in commerce with the merchant due to the relative difficulty in paying for goods and/or services that are offered by the merchant. Increasing the ability of consumers to easily and conveniently pay for desired goods and/or services may open new doors of international commerce for many merchants and may also expand the goods and/or services available to consumers.

### BRIEF SUMMARY OF THE INVENTION

The embodiments described herein provide various methods and systems for performing international payment transactions. According to one embodiment, a method for effectuating an international payment for a purchase transacted between a consumer and a merchant is provided. The method includes receiving a transaction request at a funds transfer computer system. The transaction request includes a purchase price for goods and/or services that are offered on a website of the merchant. The purchase price is typically in a currency of the merchant's country and is different from a currency of the consumer's country. The method also includes selecting, via the funds transfer computer system, a first payment service provider from a plurality of payment service providers to use for the payment transaction, where each of the payment service providers is configured to process payments in one or more different countries around the world. The method further includes transmitting at least a portion of the transaction request from the funds transfer computer system to the first payment service provider and receiving, at the funds transfer computer system and from the first payment service provider, a payment amount in the currency of the consumer's country along with a website address of the first payment service provider. The method additionally includes transmitting, from the funds transfer computer system and to the merchant, the payment amount and the website address of the first payment service provider for display to the consumer such that the consumer may communicate with the first payment service provider to complete the payment transaction. The method additionally includes receiving, at the funds transfer computer system and from the payment service provider, a confirmation of payment and transmitting the confirmation of payment from the funds transfer computer system to the merchant.

In some embodiments, the first payment service provider may be selected based on the consumer's country. In some embodiments, the method may additionally include settling the payment transaction, via the funds transfer computer system, so as to effect payment of funds to the merchant in the currency of the merchant's country. In some embodiments, the method may additionally include receiving, at a foreign exchange system and from the first payment service provider, the purchase price for goods or services being offered on the website of the merchant and transmitting the payment amount from the foreign exchange system to the first payment service provider. In the latter embodiment, the method may additionally include receiving, at the foreign exchange system, a settlement of funds in the currency of the consumer's country and sending, from the foreign exchange system, a settlement of funds in the currency of the merchant's country. In some embodiments, the method may additionally include selecting, from a plurality of acquirer systems, a first acquirer system that is configured to settle payments in the merchant's country and transmitting settlement information from the funds transfer computer system to the first acquirer system for settlement of the payment transaction.

According to another embodiment, a method for effectuating a payment for a purchase transacted between a consumer located in one country and a merchant located in another country is provided. The method includes receiving, at a funds transfer computer system, a request to make a payment for a purchase transacted between the consumer and the merchant. The request may be to pay for goods and/or services being purchased from a website of the merchant. A price of the goods and/or services may be in a currency of the merchant's country that is different from a currency of the consumer's country. The method also includes transmitting at least a portion of the request from the funds transfer computer system to a payment service provider and receiving, at the funds transfer computer system and from the payment service provider, a payment amount in the consumer's currency along with a website address of the payment service provider.

The method further includes transmitting, from the funds transfer computer system to the merchant, the payment amount and the website address for display to the consumer such that the consumer may communicate with the payment service provider to complete the payment transaction. The method additionally includes receiving, at the funds transfer computer system and from the payment service provider, a confirmation of payment and transmitting the confirmation of payment from the funds transfer computer system to the merchant.

In some embodiments, the payment service provider may be located in the consumer's country. In some embodiments, the method may additionally include selecting, via the funds transfer computer system, the payment service provider from a plurality of payment service providers, where each payment service provider is configured to process payments in one or more countries. In such embodiments, the payment service provider may be selected based on one or more of the following: the consumer's country, the consumer's currency, a selection from the consumer, and/or a selection from the merchant. In some embodiments, the method may additionally include settling the payment transaction via the funds transfer computer system so as to effect payment of funds to the merchant in the currency of the merchant's country. In some embodiments, the method additionally includes transmitting settlement information to an acquirer system for settlement of the payment transaction.

According to another embodiment, a system for effectuating a payment for a purchase transacted between a consumer located in one country and a merchant located in another country is provided. The system includes a funds transfer computer system having a processor and a memory device. The memory device has instructions stored thereon that, when executed by the processor, cause the funds transfer computer system to perform one or more of the following processes: receive a request to make a payment for a purchase transacted between the consumer and the merchant; transmit at least a portion of the request to a payment service provider; receive, from the payment service provider, a payment amount in the consumer's currency along with a website address of the payment service provider; transmit to the merchant, the payment amount and the website address for display to the consumer; receive a confirmation of payment from the first payment service provider; and/or transmit the confirmation of payment to the merchant.

The above described request may be to pay for goods and/or services being purchased from a website of the merchant, and a price of the goods and/or services may be in a currency of the merchant's country that is different from a currency of the consumer's country. The website address may be displayed to the consumer to allow the consumer to communicate with the payment service provider to complete the payment transaction. In some embodiments, the payment service provider may be s located in the consumer's country.

In some embodiments, the instructions may cause the funds transfer computer system to select the payment service provider from a plurality of payment service providers, where each payment service provider is configured to process payments in one or more countries. In such embodiments, the payment service provider may be selected based on one or more of the following: the consumer's country, the consumer's currency, a selection from the consumer, and/or a selection from the merchant.

In some embodiments, the instructions may cause the funds transfer computer system to settle the payment transaction so as to effect payment of funds to the merchant in the currency of the merchant's country. In some embodiments, the instructions may cause the funds transfer computer system to: receive, from the payment service provider, the purchase price for goods and/or services being offered on the website of the merchant and transmit the payment amount to the first payment service provider.

In some embodiments, the instructions may cause the funds transfer computer system to: receive a settlement of funds in the currency of the consumer's country and send a settlement of funds in the currency of the merchant's country. In some embodiments, the instructions may cause the funds transfer computer system to: select an acquirer system from a plurality of acquirer systems and transmit settlement information to the selected acquirer system for settlement of the payment transaction. The selected acquirer system may be configured to settle payments in the merchant's country.

### BRIEF DESCRIPTION OF THE DRAWINGS

The present disclosure is described in conjunction with the appended figures:

FIG. 1 illustrates a payment system that may be used in performing international payment transactions according to an embodiment.

FIG. 2 illustrates a simple system and flow diagram of an international payment transaction according to one embodiment.

FIG. 3 illustrates another embodiment of a system and flow diagram of an international payment transaction according to an embodiment.

FIG. 4 illustrates a method for affecting an international payment for a purchase transacted between a consumer and a merchant that are located in different countries according to an embodiment.

FIG. 5 illustrates a computer system that may be used to implement the methods and systems described herein according to an embodiment of the present invention.

In the appended figures, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

### DETAILED DESCRIPTION OF THE INVENTION

The ensuing description provides exemplary embodiments only, and is not intended to limit the scope, applicability or configuration of the disclosure. Rather, the ensuing description of the exemplary embodiments will provide those skilled in the art with an enabling description for implementing one or more exemplary embodiments. It being understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other elements in the invention may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed, but could have additional steps not discussed or included in a figure. Furthermore, not all operations in any particularly described process may occur in all embodiments. A process may correspond to a method, a function, a procedure, a subroutine, a subprogram, etc. When a process corresponds to a function, its termination corresponds to a return of the function to the calling function or the main function.

The term “machine-readable medium” or “memory device” includes, but is not limited to portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments of the invention may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

The embodiments described herein provide various methods and systems for performing international payment transactions. The embodiments allow merchants and consumers in various countries to easily and quickly transact business. For example a consumer located in Germany may quickly and easily purchase a product that is being offered for sale on a website of a merchant located in the United States. Conventional systems do not allow for quick and easy purchase of such items because the payment networks in different countries often are incompatible and/or unable to operate with one another. For example, PayPal® is a common online payment service provider that is used in the United States. Sofort® is a common online payment service provider that is used in northern Europe. Each of these online payment service providers service merchants and consumers in their own respective countries or regions, but often do not work outside of those countries or regions. As such, a consumer desiring to purchase an item the United States while using Sofort® as the online payment service provider is currently unable to do so. Further, the various online payment service providers are often unable to work with multiple currencies, such as to convert a sell of an item in U.S. dollars to Euros.

The embodiments described herein provide a funds transfer system that is able to communicate and work with one or more payment service providers and settlement engines or services in order to enable international payments in a quick and convenient manner. This allows merchants to expand their customer base by offering goods and/or services for sale in foreign countries where commerce may be currently unavailable or incovenient. The funds transfer system also works with a foreign exchange system to quickly and easily convert funds from one currency to another and thereby allow quick and easy international payments to be transacted.

According to one embodiment, the funds transfer system may determine the geographic location of the merchant and consumer and select an appropriate payment service provider and settlement engine based on the geographic locations of the consumer and merchant. Upon selecting an appropriate payment service provider, the funds transfer system may acquire an address to the website of the payment service provider and may forward the website address to consumer to allow the consumer to correspond directly with the payment service provider to complete a payment transaction. The payment information may be routed to a foreign exchange system so that funds may be converted from a currency of the consumer to a currency of the merchant. A settlement engine may then settle the payment transaction so that funds are ultimately routed to the control of the merchant. Additional aspects of the payment methods and systems will be more evident with reference to the figures described herein.

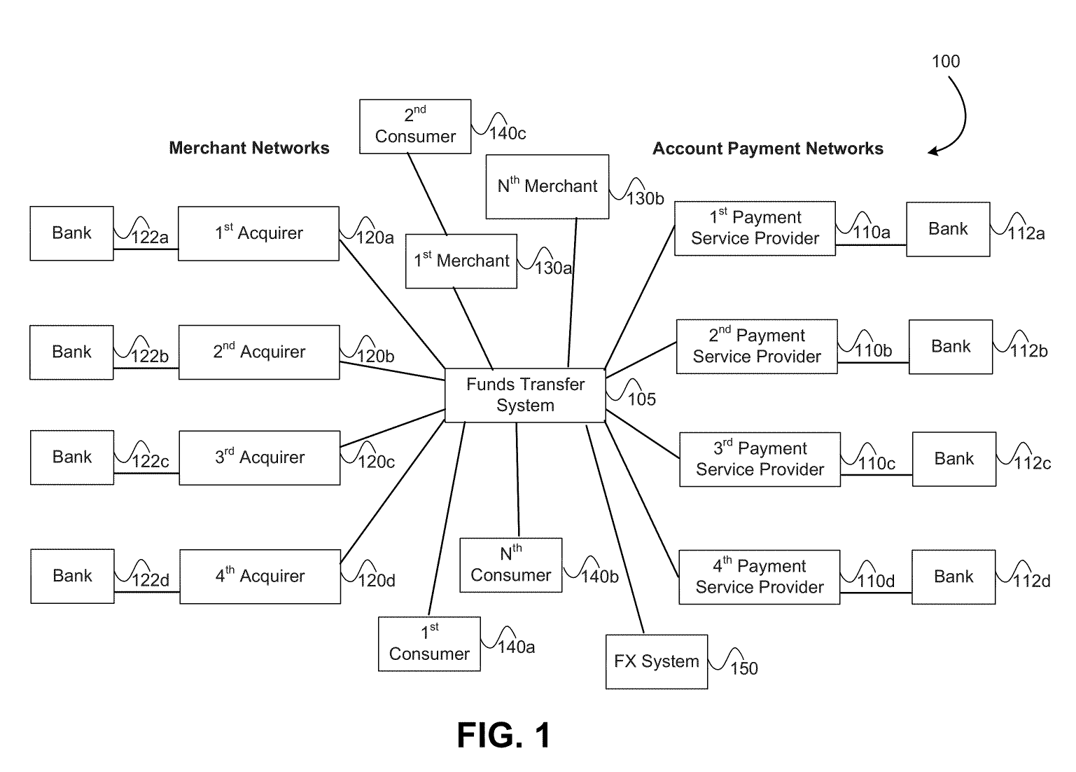

Referring to FIG. 1, illustrated is an embodiment of a international payment system 100 that may be used in an international payment transaction. System 100 includes a funds transfer system 105 that is communicatively coupled with various other entities or systems in order to allow the system 100 to perform an international payment transaction. Specifically, funds transfer system 105 is communicatively coupled with the plurality of payment service providers 110a-d. Each of the payment service providers 110a-d are in turn coupled with a bank 112a-d, respectively, and are configured to withdraw funds from the banks during a payment transaction.

In a specific embodiment, the payment service providers 110a-d, or some of the payment service providers, are e-commerce businesses that allow funds to be quickly and easily transferred in online payment transactions. The payment service providers 110a-d may offer various services to their users, such as online payment accounts, online banking, online payment services with or without requiring customer registration, and the like. In one embodiment, a specific service that may be offered by one or more of the payment service providers 110a-d may be allowing customers to securely purchase goods and/or services online (and/or receive money from other online customers) using online direct transfers from one or more banks 112a-d.

Each of the payment service providers 110a-d may serve a specific region of the world, such as the North America, Europe, Asia, South America, and the like. The payment service providers 110a-d may be specifically oriented at serving one or more specific region or areas of the world. In some embodiments, the service areas of one or more payment service providers 110a-d may overlap, but one of the payment service providers may be more widely accepted or more commonly used than another, and thus, may be a preferred payment system for use in a given region or area. Exemplary payment service provider systems 110a-d include Giropay®, iDEAL®, Sofort®, PayPal®, Interac Online®, and the like, which are each more readily used in specific regions around the world.

While each of the payment service providers 110a-d may be widely used in a specific region of the world, none of the payment service providers 110a-d may be universally used in all regions of the world. Accordingly, if a consumer in one region desires to purchase a good or service in another region, the consumer may be hindered or discourage from doing so due to a lack of familiarity with a payment service provider 110a-d that is more commonly used or accepted in the merchant's region of the world. Further, some of the payment service providers 110a-d may be ill-equipped to handle foreign exchange processes and thus not able to provide cross currency transactions.

Funds transfer system 105 is also coupled with a plurality of settlement systems or acquires 120a-d. The acquire systems 120a-d are typically financial institutions that provide settlement services for merchants. For example, the acquire systems 120a-d may process credit and/or debit card payments and exchange funds with issuing banks 122a-d on behalf of merchants. The acquire systems 120a-d may pay merchants on a periodic basis, such as when a transaction is performed, at the end of a business day, or according to some other payment schedule. Like the payment service providers 110a-d, the acquire systems 120a-d may each serve a specific region of the world, such as the North America, Europe, Asia, South America, and the like. In some embodiments, one or more acquire systems 120a-d may have service areas that overlap, but one of the acquire systems 120a-d may be more widely used and/or preferred within a given region or area. Exemplary payment service provider systems 110a-d include FirstData®, AsiaPay®, Barclaycard®, and the like, which are each more readily used in specific regions around the world.

Funds transfer system 105 is further communicatively coupled with a plurality of merchants 130a-b. Funds transfer system 105 is able to receive information from and transmit information to the merchants as described herein. For example, a transaction request, or a request to perform a payment transaction, is typically received at the funds transfer system 105 from one or more merchants 130a-b. In response, the funds transfer system 105 communicates with one or more payment service providers 110a-d and/or one or more acquirer systems 112a-d in order to perform the payment transaction. In performing the payment transaction, the funds transfer system 105 may transmit a payment amount and URL to the merchant 130a-b as described herein. Other information, such as a payment confirmation and the like, may be transmitted to the merchants 130a-b and/or information received from the merchants as needed.

In some embodiments, funds transfer system 105 may also be communicatively coupled with one or more consumers 140a-b to allow the consumers to communicate with the funds transfer system 105, such as to provide account information, security authorization information, and the like to the funds transfer system 105. In other embodiments, the consumers 140c may communicate directly with the merchants 130a-b, payment service providers 110a-d, and/or acquire systems 120a-d as is necessary to complete a payment transaction. In the latter embodiments, the consumers 140c may be unaware of the funds transfer system 105 and/or the processes performed by the funds transfer system 105. In such embodiments, the consumer 140c may simply access the website of a merchant 130a-b, select to purchase one or more goods or services, and follow any payment instructions that are displayed on the merchant's website. In this manner, the overall experience of the consumer 140c in completing a payment transaction with the merchant 130a-b may be relatively convenient and seamless.

The funds transfer system 105 may also be communicatively coupled with a foreign-exchange system 150 that is configured to convert currency that is commonly used in a country of the consumer to a currency that is commonly used in a country of the merchant. During the payment transaction, the funds transfer system 105 may communicate information to the foreign-exchange system 150 about any currency conversion that is needed in order to complete the transaction. In another embodiment, the payment service providers 110a-d and/or acquire systems 120a-d may be communicatively coupled with the foreign-exchange system 150 in order to transmit to and/or receive any currency conversion information from the foreign-exchange system 150 that may be needed to complete the payment transaction.

In some embodiments, the funds transfer system 105 may perform the processes of, or include one or more of, the systems described herein, such as the payment service provider systems 110a-d, acquire systems 120a-d, the foreign exchange system 150, and the like. In such embodiments, one or more of the processes described herein may be performed by the funds transfer system 105 and/or under the control of the funds transfer system 105. For example, in a specific embodiment, the funds transfer system 105 may perform one or more processes performed by the foreign-exchange system 150 and/or one or more processes formed by the acquire systems 12a-d.

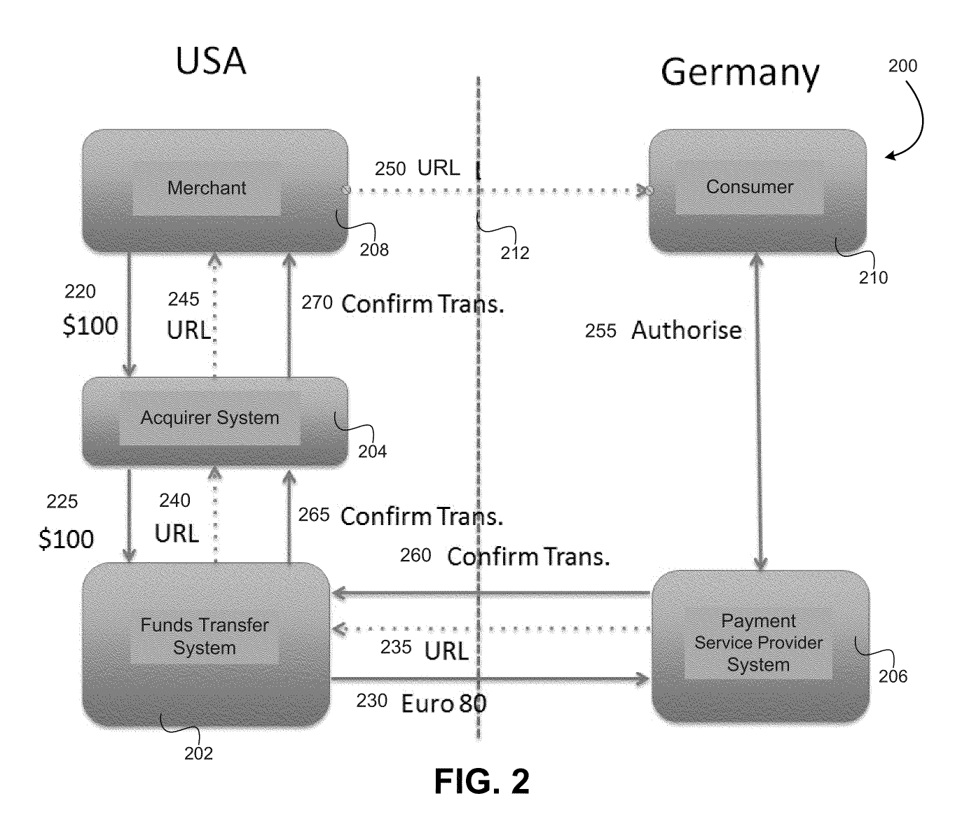

Referring now to FIG. 2, illustrated is a simple system and a flow diagram of an international payment transaction 200 that may be performed with a funds transfer system. Specifically, FIG. 2 illustrates a funds transfer system 202 that is communicatively coupled with a payment service provider system 206 and an acquire system 204. FIG. 2 also illustrates a dividing line 212 that may represent a geographical division between the merchant 208 and a consumer 210 to illustrate that the consumer and merchant are located in different countries. In this example, the merchant 208 may be located in the United States while the consumer 210 is located in a European country, such as in Germany.

The payment transaction process begins at step 220 in which the merchant 208 transmits a payment request to the acquire system 204. In this example the payment request is for a payment of approximately US $100 for goods and/or services that are offered on a website of the merchant. The payment request may include information about the goods and/or services to be purchased from the merchant's website and/or some information about the consumer 210. The information about the consumer may include a geographic location of the consumer, the consumer's name, address, a desired payment method, and the like. The payment request is typically transferred to acquire system 204 from merchant 208 in response to consumer 210 browsing the merchant's website and selecting one or more goods and/or services to purchase. At step 225, some or all of the payment request information is transmitted from the acquire system 204 to the funds transfer system 202. The funds transfer system 202 may use this information to select a payment service provider system 206 for use in completing the international payment transaction. For example, the funds transfer system 202 may determine or otherwise recognize that the consumer 210 is located in Germany, and/or that the consumer 210 desires to pay in Euros, and based on this information, may select a payment service provider system 206 that is commonly used, accepted, or otherwise preferred in Germany, such as Sofort®. In some embodiments, the payment request that is transmitted from the merchant 208 may include a consumer 210 and/or merchant 208 selection of a preferred payment service provider system 206 to use in completing the international payment transaction.

Although not shown, the funds transfer system 202 may determine a currency conversion between the consumer's currency and the merchant's currency. In some embodiments, this process may involve transmitting the payment information to a foreign exchange system (not shown) that is separate from the funds transfer system 202, although in other embodiments the currency conversion process may be performed by the funds transfer system 202. At step 230, the funds transfer system 202 transmits the payment request information to the payment service provider system 206. The payment request information may be transmitted in the currency of the consumer to 10 at this point. In another embodiment, the payment request information may be transmitted to the payment service provider system 206 in the currency of the merchant 208 and the payment service provider system 206 may perform or request currency conversion information from a foreign exchange system to determine a converions of the currency to a currency used in the consumer 210's country.

In response to the payment service provider system 206 receiving the payment request information, the payment service provider system 206 sends a website address (hereinafter URL) to the funds transfer system 202 (i.e. step 235). The payment service provider system 206 may also send a payment amount in the currency of the consumer's country for the goods or services being purchased from the merchant's website, unless the currency conversoin was previously performed by the funds transfer system 202. At step 240, the funds transfer system 202 transmits the URL and the payment amount in the currency of the consumer's country to the acquire system 204. At step 245, the acquire system 204 routes this information (i.e., the URL and payment amount) to the merchant 208 for display on the merchant's website. The merchant's website then displays this information to the consumer 210, afterwhich the consumer 210 may determine whether they wish to continue with the transaction or wish to cancel the transaction. If the consumer 210 wishes to continue with the transaction, the consumer 210 may click on a link of the URL (i.e. step 250), or otherwise capture the URL information of the payment service provider system 206. The consumer is then routed or transferred to a website of the payment service provider system 206.

At step 255, the consumer 210 authorizes and/or completes a payment transaction with the payment service provider system 206. This process may involve the consumer 210 entering relevant payment and/or personal information into the website of the payment service provider system 206, registering with the payment service provider system, selecting a payment option, entering authentication information into the website of the payment service provider system, logging in to a pre-existing account maintained by the payment service provider system, and the like. At step 260, the payment service provider system 206 transmits a payment confirmation message to the funds transfer system 202, which is in turn routed or transmitted to the acquire system 204 (step 265) and subsequently to the merchant 208 (step 270). Upon receiving the payment confirmation, the international payment transaction is essentially complete and the merchant 208 may provide any purchased goods and/or services to the consumer 210.

As is illustrated in FIG. 2, one or more of the systems used in performing the international payment transaction may be located in different countries. For example, FIG. 2 illustrates the acquire system 204 and funds transfer system 202 located in or near a country of the merchant 208 (e.g., the United States), while the payment service provider system 206 is located in or near a country of the consumer 210 (e.g., Germany). In many embodiments, the payment service provider system 206 that is selected by the funds transfer system 202 may be located in a country that is near the consumer 210, since relatively local payment service provider systems are more commonly used, accepted, or preferred within a local region. In other embodiments, all of the systems may be located in or near the same country, or each of the systems may be located in separate countries.

In some embodiments, the international payment process described herein may be performed via a wireless network instead of or in addition to being performed online. For example, a smart phone or other wireless device may be used in performing the international payment transaction. Via a wireless network and with a smart phone or wireless device, the consumer 210 may browse a website of the merchant 208, or a smart phone application store of the merchant 208, and make a selection of one or more goods and/or services offered by the merchant 208. The international payment transaction process may function similar to that described above with the consumer 210 using the smart phone or wireless device to access the URL of the payment service provider system 206 and authorize the payment transaction.

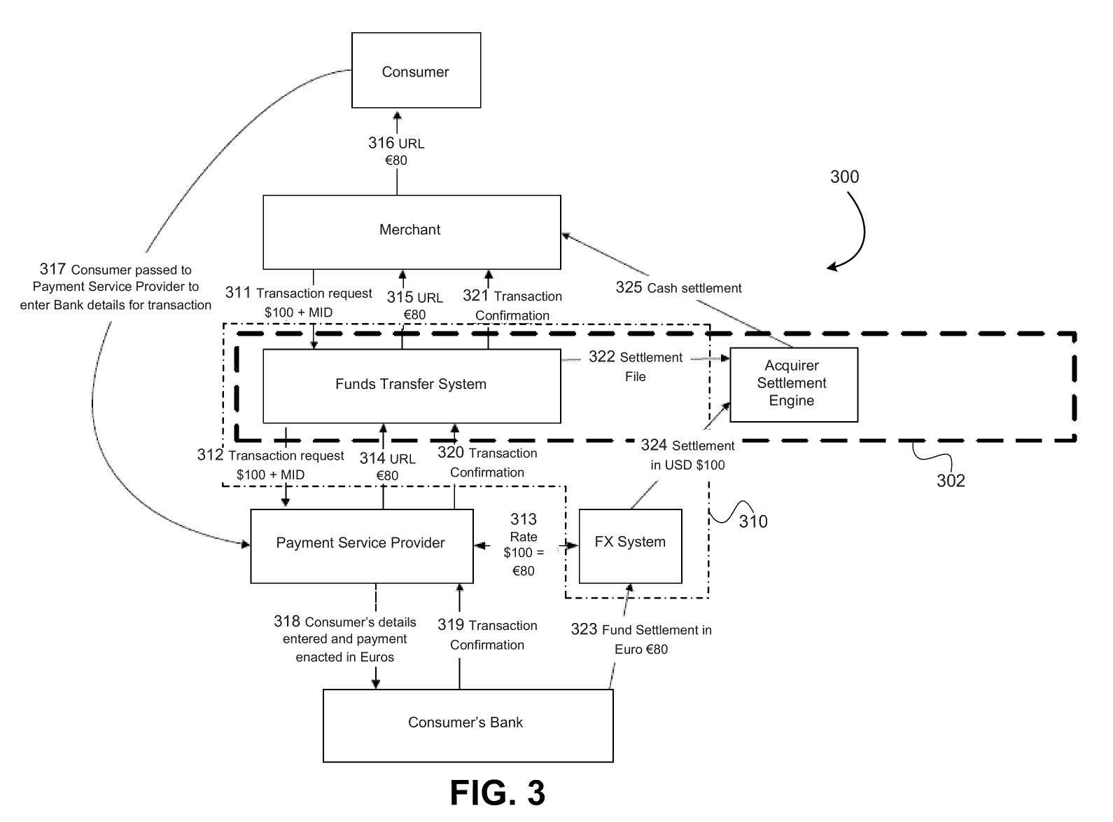

Referring now to FIG. 3, illustrated is another embodiment of a system and flow diagram of an international payment transaction 300 that may be performed with a funds transfer system. The system of FIG. 3 includes one or more of the systems or entities previously described; specifically, the funds transfer system, payment service provider, foreign exchange system, acquire system, one or more banks, one or more merchants, and one or more consumers. The illustrated system is a simplified schematic and it should be realized that the system may include more or fewer systems or entities than those illustrated.

Further, in some embodiments one or more of the processes described in relation to FIG. 3 may be performed by the same entity, such as the funds transfer system. For example, dashed line 302 that is positioned around the funds transfer system and the acquirer system/settlement engine illustrates that, in one embodiment, the funds transfer system may perform both the funds transfer processes and the settlement processes. Similarly, dashed line 310 that is positioned around the funds transfer system and the foreign exchange system illustrates that in one embodiment the funds transfer system may perform both the funds transfer processes and the foreign exchange/currency conversion processes. Although not illustrated herein, in other embodiments the funds transfer system may perform any combination the processes of the payment service provider, foreign exchange system, acquirer/settlement engine system (hereinafter acquirer system), and the like.

The process of FIG. 3 begins at step 311 wherein the merchant transmits a transaction request to the funds transfer system. The transaction request may include a transaction value (e.g., $100) for goods and/or services selected by the consumer from a website, App Store, and the like of the merchant. The transaction value may be in a currency of the merchant's country. The transaction request may also include additional information, such as a merchant identification (MID), consumer identification, an identification of the consumer's country and/or currency, and the like. The MID may be used by the funds transfer system and/or payment service provider to correlate or associate information that is transmitted or otherwise communicated between the various systems during the performance of a payment transaction. For example, when information is passed from the payment service provider to the funds transfer system, the MID may be used to correlate or associate this information with the appropriate pending payment transaction. Similarly, as the consumer is passed to the payment service provider, the MID may be used to correlate or associate the payment or other information provided by the consumer with the appropriate pending payment transaction.

At step 312, some or all of the information of the transaction request (e.g., the MID and transaction value) is transmitted from the funds transfer system to an appropriate payment service provider. As described herein, the funds transfer system may select a payment service provider from a plurality of payment service providers with which the funds transfer system is communicatively coupled. The funds transfer system may select the payment service provider based on information that is contained within the transaction request and/or any other information that is obtained from the merchant and/or consumer. For example, in one embodiment the funds transfer system may select a payment service provider based on a geographic location (e.g., country) of the consumer. For example, the funds transfer system may recognize that the consumer is located in or near Germany and select Sofort® as the payment service provider since Sofort® is an online payment processing system that is commonly used and accepted in this geographic region. In other embodiments, the payment service provider may be selected based on a currency to be used by the consumer in the transaction, a payment service provider selection by the consumer and/or merchant, and the like. For example, the consumer may select to use a payment service provider with which they are registered or otherwise have familiarity.

In some embodiments, the payment transaction may involve multiple consumers that are distributed in one or more geographic locations. In such instances, the funds transfer system may select a payment service provider for each of the consumers based on any of the criteria provided herein. Each of the consumers may be responsible for paying for a portion of the total cost of the goods and/or services being purchased, and may be routed to an appropriate payment service provider system in order to provide the respective funds due. In this manner, more than one payment service provider may be used in completing an international payment transaction.

At step 313, the payment service provider may obtain currency conversion information from the foreign exchange system such as by transmitting the transaction value (e.g. $100) to the foreign exchange system and receiving a corresponding conversion of the transaction value in a currency of the consumer's country (e.g. [symbol] 80). As described herein, in some embodiments the foreign exchange system may be operated by or component of the funds transfer system, in which case the funds transfer system may transmit foreign-exchange information to the payment service provider in step 312 and/or communicate with the payment service provider in step 313. At step 314, and in response to receiving the foreign-exchange information, the payment service provider transmits the converted transaction value (e.g. [symbol] 80) and a URL or website address of the payment service provider to the funds transfer system. At step 315, the funds transfer system transmits the converted transaction value (e.g. [symbol] 80) and URL to the merchant for display on the website, App Store, and the like that is offering the goods and/or services of interest to the consumer. The consumer may then view the converted transaction value (e.g. [symbol] 80) and determine whether to continue with the payment transaction. If the consumer decides to proceed with the payment transaction, the consumer may click on a link of the payment service providers URL and/or otherwise capture the URL information.

Clicking on the URL link, or otherwise capturing the URL, passes the consumer to the payment service provider's website as shown in step 317. This allows the consumer to input, or otherwise provide, payment information to the payment service provider, such as a bank account number, credit card number, debit account information, and the like. At step 318, the payment service provider may then transmit some or all of this information to the consumer's bank in order to authorize the payment transaction. At step 319, consumer's bank transmits a transaction confirmation message to the payment service provider. This message, or portion thereof, is then transmitted from the payment service provider to the funds transfer system (step 320) and from the funds transfer system to the merchant (step 321) in order to inform the merchant that the payment transaction has been accepted. The merchant may then provide the consumer with the goods and/or services desired as is commonly known in the art.

At step 322, a settlement file may be transmitted to an acquirer or settlement engine in order to settle the payment transaction and pay the merchant for the goods or services sold. As described herein, in some embodiments the funds transfer system may perform the acquirer or settlement engine processes. In other embodiments, a separate entity may perform the settlement processes. In the latter embodiment, the funds transfer system may select an appropriate acquirer system from a plurality of acquirer systems with which the funds transfer system is communicatively coupled. The funds transfer system may select the acquirer system based on information about the merchant or obtained from the MID. For example, in one embodiment the funds transfer system may select an acquirer system based on a geographic location (e.g., country) of the merchant. For example, the funds transfer system may recognize that the merchant is located in or near the United States and select First Data® as the acquirer system since First Data® commonly settles payment transactions in the United States. In other embodiments, the acquirer system may be selected based on a relationship between the merchant and the acquirer system or based on any other criteria. The settlement file transmitted to the acquirer system at step 322 may include information that enables the acquire system to provide funds to a bank associated with the merchant or otherwise deliver the funds to the control of the merchant.

At step 323, a settlement of funds and a currency of the consumer (e.g., [symbol] 80) may be sent from the consumer's bank to the foreign-exchange system. The foreign-exchange system may then send a settlement of funds and a currency of the merchant (e.g., $100) to the acquire system at step 324. At step 325, acquire system may provide the funds to a bank associated with the merchant or otherwise provide the funds to the merchant.

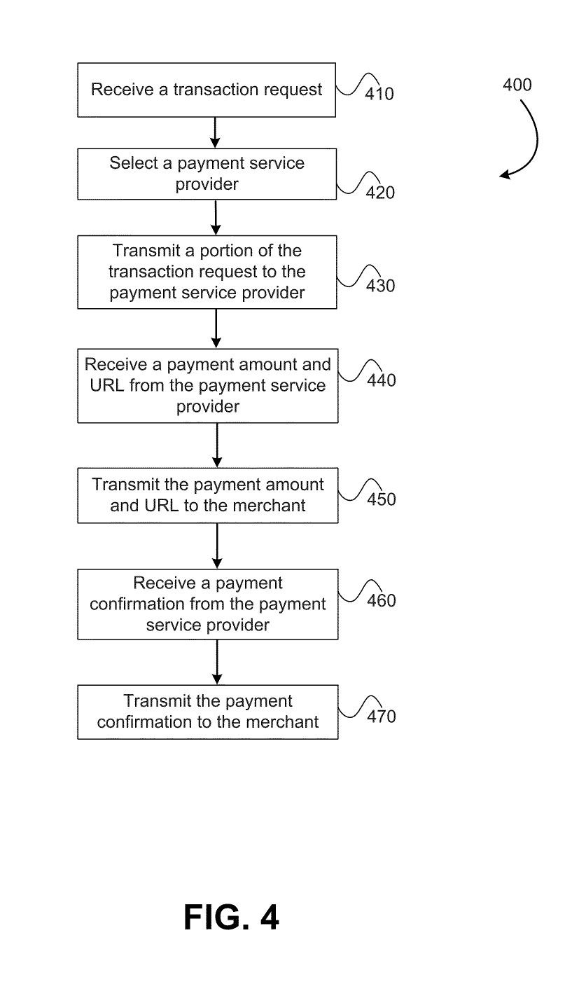

Referring now to FIG. 4, illustrated is a method 400 for affecting an international payment for a purchase transacted between a consumer and a merchant that are located in different countries. At step 410, a transaction request is received at a funds transfer computer system. The transaction request may include a purchase price for goods or services that are being offered on a website of the merchant. The purchase price of the goods or services being offered are typically in a currency of the merchant's country and are different from a currency of the consumer's country. At step 420, a payment service provider is selected by the funds transfer computer system from among a plurality of payment service providers. As described herein, each of the payment service providers are configured to process payments in one or more different countries or regions of the world. The payment service provider that is selected for use in completing the payment transaction may be configured to specifically service the geographic region of the consumer, or may otherwise be commonly used or preferred in the geographic region of the consumer. In other embodiments, the selected payment service provider may be based on a preference of the consumer.

At step 430, at least a portion of the transaction request is transmitted from the funds transfer computer system to the selected payment service provider. At step 440, a payment amount in the currency of the consumer's country is received at the funds transfer computer system from the selected payment service provider. The payment amount may be received along with a website address of the selected payment service provider. At step 450, the funds transfer computer system transmits the payment amount and the website address of the selected payment service provider to the merchant. The payment amount and website address or transmitted to the merchant for display to the consumer via the merchant's website. This allows the consumer to communicate with the selected payment service provider to complete the payment transaction. At step 460, a confirmation of payment is received at the funds transfer computer system from the selected payment service provider. At step 470, the confirmation of payment is transmitted from the funds transfer computer system to the merchant. At this point the international payment transaction is essentially complete and the merchant may provide the goods and/or services to the consumer.

In some embodiments, the method may also include settling the payment transaction via the funds transfer computer system so as to effect payment of funds to the merchant in the currency of the merchant's country. In one embodiment, settling the payment transaction via the funds transferred computer system may involve the funds transfer computer system performing the settlement process. In another embodiment, the funds transfer computer system may facilitate in settling the payment transaction by selecting an acquirer system to use in the settlement process from among a plurality of acquirer systems that are communicatively coupled with the funds transfer system. The acquirer system may be selected based on the acquirer system being configured to settle payments in the merchant's country. In such embodiments, the funds transfer computer system may transmit settlement information to the selected acquirer system for settlement of the payment transaction.

The method may further include receiving the purchase price for goods or services being offered on the website of the merchant and transmitting the payment amount after the purchase price is converted from the currency of the merchant's country to the currency of the consumer's country. In some embodiments, the funds transfer computer system may perform the currency conversion as described herein. In other embodiments, a foreign-exchange system that is separate from the funds transfer computer system may be used to perform the currency conversion. In such embodiments, the purchase price for the goods or services may be received from the selected payment service provider or from the funds transfer computer system.

In some embodiments, the method may additionally include receiving a settlement of funds in the currency of the consumer's country and sending a settlement of funds in the currency of the merchant's country. As described herein, this settlement process may be performed by the funds transfer computer system, or by the foreign exchange system is separate from the funds transfer computer system.

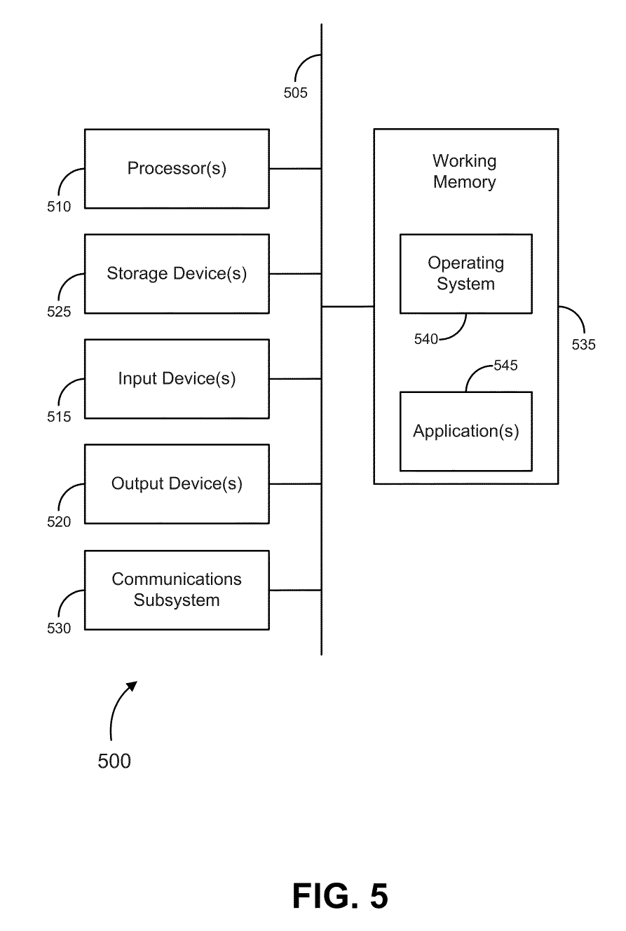

To perform the actions of the payment transactions, a computer system 500 as illustrated in FIG. 5 may be used. The computer system 500 may also represent one or more components of the funds transfer system, payment process systems, acquirer system, switch, bank, and/or any of the other previously mentioned computing devices described herein. It should be noted that FIG. 5 is meant only to provide a generalized illustration of various components, any or all of which may be utilized as appropriate. FIG. 5, therefore, broadly illustrates how individual system elements may be implemented in a relatively separated or relatively more integrated manner.

The computer system 500 is shown comprising hardware elements that can be electrically coupled via a bus 505 (or may otherwise be in communication, as appropriate). The hardware elements may include one or more processors 510, including without limitation one or more general-purpose processors and/or one or more special-purpose processors (such as digital signal processing chips, graphics acceleration processors, and/or the like); one or more input devices 515, which can include without limitation a mouse, a keyboard and/or the like; and one or more output devices 520, which can include without limitation a display device, a printer and/or the like.

The computer system 500 may further include (and/or be in communication with) one or more storage devices 525, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 500 might also include a communications subsystem 530, which can include without limitation a modem, a network card (wireless or wired), an infrared communication device, a wireless communication device and/or chipset (such as a Bluetooth™ device, an 802.11 device, a WiFi device, a WiMax device, cellular communication facilities, etc.), and/or the like. The communications subsystem 530 may permit data to be exchanged with a network (such as the network described below, to name one example), other computer systems, and/or any other devices described herein. In many embodiments, the computer system 500 will further comprise a working memory 535, which can include a RAM or ROM device, as described above.

The computer system 500 also can comprise software elements, shown as being currently located within the working memory 535, including an operating system 540, device drivers, executable libraries, and/or other code, such as one or more application programs 545, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 525 described above. In some cases, the storage medium might be incorporated within a computer system, such as the system 500. In other embodiments, the storage medium might be separate from a computer system (e.g., a removable medium, such as a compact disc), and or provided in an installation package, such that the storage medium can be used to program, configure and/or adapt a general purpose computer with the instructions/code stored thereon. These instructions might take the form of executable code, which is executable by the computer system 500 and/or might take the form of source and/or installable code, which, upon compilation and/or installation on the computer system 500 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 500) to perform methods in accordance with various embodiments of the invention. According to a set of embodiments, some or all of the procedures of such methods are performed by the computer system 500 in response to processor 510 executing one or more sequences of one or more instructions (which might be incorporated into the operating system 540 and/or other code, such as an application program 545) contained in the working memory 535. Such instructions may be read into the working memory 535 from another computer-readable medium, such as one or more of the storage device(s) 525. Merely by way of example, execution of the sequences of instructions contained in the working memory 535 might cause the processor(s) 510 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 500, various computer-readable media might be involved in providing instructions/code to processor(s) 510 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 525. Volatile media include, without limitation, dynamic memory, such as the working memory 535. Transmission media include, without limitation, coaxial cables, copper wire and fiber optics, including the wires that comprise the bus 505, as well as the various components of the communication subsystem 530 (and/or the media by which the communications subsystem 530 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 500. These signals, which might be in the form of electromagnetic signals, acoustic signals, optical signals and/or the like, are all examples of carrier waves on which instructions can be encoded, in accordance with various embodiments of the invention.

The communications subsystem 530 (and/or components thereof) generally will receive the signals, and the bus 505 then might carry the signals (and/or the data, instructions, etc. carried by the signals) to the working memory 535, from which the processor(s) 505 retrieves and executes the instructions. The instructions received by the working memory 535 may optionally be stored on a storage device 525 either before or after execution by the processor(s) 510.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in function and arrangement of elements without departing from the spirit and scope of the invention.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the necessary tasks may be stored in a computer-readable medium such as a storage medium. Processors may perform the necessary tasks.

Having described several embodiments, it will be recognized by those of skill in the art that various modifications, alternative constructions, and equivalents may be used without departing from the spirit of the invention. Additionally, a number of well-known processes and elements have not been described in order to avoid unnecessarily obscuring the present invention. Accordingly, the above description should not be taken as limiting the scope of the invention.

What is claimed is:

1. A method for effectuating an international payment for a purchase transacted between a consumer and a merchant, the method comprising:
receiving a transaction request at a funds transfer computer system, the transaction request comprising a purchase price for goods or services being offered on a website of the merchant, the purchase price being in a currency of the merchant's country that is different from a currency of the consumer's country;
selecting via the funds transfer computer system a first payment service provider from a plurality of payment service providers to use for the payment transaction, wherein each payment service provider is configured to process payments in one or more different countries;
transmitting at least a portion of the transaction request from the funds transfer computer system to the first payment service provider;
receiving at the funds transfer computer system from the first payment service provider a payment amount in the currency of the consumer's country along with a website address of the first payment service provider;
transmitting from the funds transfer computer system to the merchant the payment amount and the website address of the first payment service provider for display to the consumer such that the consumer may communicate with the first payment service provider to complete the payment transaction;
receiving at the funds transfer computer system from the payment service provider a confirmation of payment; and
transmitting from the funds transfer computer system to the merchant the confirmation of payment.

2. The method of claim 1, wherein the first payment service provider is selected based on the consumer's country.

3. The method of claim 1, further comprising settling the payment transaction via the funds transfer computer system so as to effect payment of funds to the merchant in the currency of the merchant's country.

4. The method of claim 1, further comprising:
receiving at a foreign exchange system from the first payment service provider the purchase price for goods or services being offered on the website of the merchant; and
transmitting the payment amount from the foreign exchange system to the first payment service provider.

5. The method of claim 4, further comprising:
receiving at the foreign exchange system a settlement of funds in the currency of the consumer's country; and
sending from the foreign exchange system a settlement of funds in the currency of the merchant's country.

6. The method of claim 1, further comprising:
selecting, from a plurality of acquirer systems, a first acquirer system that is configured to settle payments in the merchant's country; and
transmitting settlement information from the funds transfer computer system to the first acquirer system for settlement of the payment transaction.

7. A method for effectuating a payment for a purchase transacted between a consumer located in one country and a merchant located in another country, the method comprising:
receiving at a funds transfer computer system a request to make a payment for a purchase transacted between the consumer and the merchant, wherein the request is to pay for goods or services being purchased from a website of the merchant where the price of the goods or services is in a currency of the merchant's country and is different from a currency of the consumer's country;
transmitting at least a portion of the request from the funds transfer computer system to a payment service provider;
receiving at the funds transfer computer system from the payment service provider a payment amount in the consumer's currency along with a website address of the payment service provider;
transmitting from the funds transfer computer system to the merchant the payment amount and the website address for display to the consumer such that the consumer may communicate with the payment service provider to complete the payment transaction;
receiving at the funds transfer computer system from the payment service provider a confirmation of payment; and
transmitting from the funds transfer computer system to the merchant the confirmation of payment.

8. The method of claim 7, wherein the payment service provider is located in the consumer's country.

9. The method of claim 7, further comprising:
selecting via the funds transfer computer system the payment service provider from a plurality of payment service providers, wherein each payment service provider is configured to process payments in one or more countries.

10. The method of claim 9, wherein the payment service provider is selected based on one or more of the following:
the consumer's country;
the consumer's currency;
a selection from the consumer; or
a selection from the merchant.

11. The method of claim 7, further comprising settling the payment transaction via the funds transfer computer system so as to effect payment of funds to the merchant in the currency of the merchant's country.

12. The method of claim 7, further comprising transmitting settlement information to an acquirer system for settlement of the payment transaction.

13. A system for effectuating a payment for a purchase transacted between a consumer located in one country and a merchant located in another country, the system comprising:
a funds transfer computer system comprising a processor and a memory device, the memory device having instructions stored thereon that, when executed by the processor, cause the funds transfer computer system to:
receive a request to make a payment for a purchase transacted between the consumer and the merchant, wherein the request is to pay for goods or services being purchased from a website of the merchant, and wherein the price of the goods or services is in a currency of the merchant's country and is different from a currency of the consumer's country;
transmit at least a portion of the request to a payment service provider;
receive from the payment service provider a payment amount in the consumer's currency along with a website address of the payment service provider;
transmit to the merchant, the payment amount and the website address for display to the consumer such that the consumer may communicate with the payment service provider to complete the payment transaction;
receive from the first payment service provider a confirmation of payment; and
transmit to the merchant the confirmation of payment.

14. The system of claim 13, wherein the payment service provider is located in the consumer's country.

15. The system of claim 13, wherein the instructions further cause the funds transfer computer system to select the payment service provider from a plurality of payment service providers, wherein each payment service provider is configured to process payments in one or more countries.

16. The system of claim 15, wherein the payment service provider is selected based on one or more of the following:
the consumer's country;
the consumer's currency;
a selection from the consumer; or
a selection from the merchant.

17. The system of claim 13, wherein the instructions further cause the funds transfer computer system to settle the payment transaction so as to effect payment of funds to the merchant in the currency of the merchant's country.

18. The system of claim 13, wherein the instructions further cause the funds transfer computer system to:
receive from the payment service provider the purchase price for goods or services being offered on the website of the merchant; and
transmit the payment amount to the first payment service provider.

19. The system of claim 13, wherein the instructions further cause the funds transfer computer system to:
receive a settlement of funds in the currency of the consumer's country; and
send a settlement of funds in the currency of the merchant's country.

20. The system of claim 13, wherein the instructions further cause the funds transfer computer system to:
select an acquirer system from a plurality of acquirer systems, the selected acquirer system being configured to settle payments in the merchant's country; and
transmit settlement information to the selected acquirer system for settlement of the payment transaction.
